(19) United States
(12) Patent Application Publication
(10) Pub. No.: US 2024/0313833 A1
(43) Pub. Date: Sep. 19, 2024

(54) DIVERSITY-AWARE TRUNCATED LAYER SELECTION FOR LOW COMPLEXITY BEAMFORMING

(71) Applicant: Telefonaktiebolaget LM Ericsson (publ), Stockholm (SE)

(72) Inventors: Hesham MOUSSA, Ottawa (CA); Hamza SOKUN, Ottawa (CA); Israfil BAHCECI, Kanata (CA)

(21) Appl. No.: 18/576,547

(22) PCT Filed: Jul. 22, 2021
(86) PCT No.: PCT/IB2021/056642

§ 371 Date: Jan. 4, 2024

(51) Int. Cl. H04B 7/0456

(52) U.S. Cl. CPC H04B 7/0456

(57) ABSTRACT

A method and network node for diversity-aware truncated layer selection for low complexity beamforming are provided. According to one aspect, a method in a network node includes receiving a precoder rank indication, and selecting one of two precoders of different ranks one of cyclically and randomly when the indicated precoder rank is greater than 1.

### TECHNICAL FIELD

This disclosure relates to wireless communication and in particular, to diversity-aware truncated layer selection for low complexity beamforming.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

User-specific beamforming can improve coverage and capacity in 5G NR. Using common beamforming for PDCCH transmissions limits downlink (DL) coverage and capacity, and inefficiently utilizes resources. Hence, to further improve coverage and capacity in the DL, enabling user-specific PDCCH beamforming may be considered essential. One possible way to implement user-specific PDCCH beamforming is to adopt precoder matrix indicator (PMI)-based beamforming which relies on channel feedback from the wireless device (WD).

In PMI-based beamforming, the NR base station (gNB) sends downlink reference signals, e.g., channel state information reference signals (CSI-RS), which are used by the WD to estimate the channel conditions. Then, with the help of a pre-defined set of PMI codebooks, the WD identifies the index of the PMI weights that maximize throughput and reports this index to the gNB in the CSI report, along with the rank indicator (RI) and channel quality indicator (CQI). The gNB may choose to use the WD's reported PMI to beamform the channel. These reported PMI precoder weights can be used to beamform the PDCCH.

However, as the PMI matrix is designed for PDSCH multi-layer transmission, while the PDCCH is an one-layer transmission, the reuse of the reported PMI precoder weights for PDCCH beamforming is not a straightforward process, especially for WDs reporting RI of two or more. First, if the reported number of transmission layers is greater than one, choosing which layer to use for PDCCH beamforming becomes challenging. The objective is to maximize the gains from beamforming the PDCCH which can be done by using the strongest PDSCH transmission layer. Nonetheless, as there is no indication of the strongest layer in the WD's reported CSI, there is no way of knowing which layer would maximize PDCCH performance. Second, to beamform PDCCH using the precoder weights, extra hardware memory might be needed to store another copy of the PMI codebooks to be used by PDCCH. Due to hardware limitations, increasing memory might not be feasible. Lastly, PDSCH precoders are configured per PDSCH bundle, whereas PDCCH precoders are configured per resource element group (REG) bundle. Thus, when doing mapping between PDSCH bundles and PDCCH REG bundles, precoder granularities should be considered.

As indicated above, when mapping the PMI precoders of a multi-layer transmission into a single-layer transmission, finding a proper layer-index selection algorithm that is simple, light, and agnostic to precoder order is desired. This has motivated many proposals on appropriate layer selection and mapping algorithm including:
I. Layer superposition layer selection: Precoders belonging to all layers are added together, and the superposed layers are used for all the REG bundles;
II. First-layer selection: The index of the first layer is always used;
III. Random layer selection: A layer index is randomly selected among the active layers and applied to all subsequent transmissions;
IV. Random layer to bundle selection: The indices of the active layers are randomly assigned to the REG bundles;
V. Sequentially cycled layer selection: The indices of the active layers are sequentially assigned to REG bundles;
VI. Randomly shuffled cyclic layer selection: The indices of the active layers are first randomly shuffled and then assigned to the REG bundles;

However, several problems with these proposals may include the following:
I. Layer superposition layer selection: Although very simple, adding layers might lead to a transmission imbalance at the antenna terminal and saturation of the PAs. Furthermore, transmission power might exceed regulated levels, making it an infeasible solution;
II. First-layer selection: Although very simple in terms of implementation, it cannot guarantee optimal performance as the first layer is not necessarily the strongest layer of transmission;
III. Random layer selection: Choosing a single layer randomly to be used for all bundles is simple in terms of implementation; however, this method does not ensure selection of the strongest layer. Besides, the algorithm is not agnostic to the WD state, since not all WDs would necessarily report a rank high enough to include the randomly selected layer;
IV. Random layer to bundle selection: Assigning a random layer to each bundle cannot ensure optimal performance as a weak layer might be used multiple times for different bundles. Additionally, the algorithm is complex and requires extra memory space to store full PMI codebooks;
V. Sequentially cycled layer selection: This algorithm ensures uniform use of the different layers which avoids using weak layers more often like in algorithm IV. However, as the same layer will always be assigned the same bundle every slot, the algorithm might lack time diversity where some bundles might always be assigned a weak layer. Furthermore, just like algorithm IV, extra memory space to store full PMI codebooks is required.
VI. Randomly shuffled cyclic layer selection: This algorithm solves the lack of time diversity of algorithm V by shuffling the layer indices every slot before cyclically assigning them to bundles. It also ensures uniform usage of all layers. Nevertheless, as all layers can be used, extra memory space is needed to store full PMI codebooks.

### SUMMARY

Some embodiments advantageously provide a method and system for diversity-aware truncated layer selection for low complexity beamforming.

A shuffled cyclic truncated layer selection algorithm is disclosed. In this algorithm, the number of layers to map into bundles is restricted to two. If the WD reports rank greater than two, only layers 2 and 3 will always be used. The indices of the truncated active layers are then randomly shuffled and assigned to the bundles cyclically. Thus, the algorithm disclosed herein enables a low-complexity precoder selection where a multi-layer feedback can be utilized to perform lower-rank transmissions maintaining both spatial and polarization diversity embedded within the available feedback. Such scenarios include single-layer transmissions such as PDCCH or rank reallocation (whether in single-user or multi-user multiple input multiple output (MIMO) transmissions) where one or a few layers is preferred to be transmitted based on knowledge from the multi-layer precoders. In some embodiments, the precoder selection algorithm disclosed herein works for well-structured codebooks such as those in 3GPP or for more generic codebooks that utilize both directional and polarization diversity.

In some embodiments, the PMI precoder weights of a multi-layer transmission are mapped into a single transmission or a dual layer transmission or transmission on a few layers. Some advantages of some embodiments may include the following:
i. An algorithm considers the beam's directional and phase diversity when performing layer selection and truncation, which may ensure maximization of performance;
ii. In case rank restrictions are desired or required for data (PDSCH in 3GPP) or control traffic (PDCCH in 3GPP), the method defines a low-complexity precoder selection to determine one or a few precoders from within a multi-layer precoder;
iii. The algorithm is simple (low-complexity selection) in terms of implementation;
iv. The number of layers used is truncated to two which reduces memory requirements and decreases the algorithm's complexity by decreasing the number of permutations;
v. In case the rank reported is greater than 2, layers 2 and 3 are always used to ensure directional and phase diversity which improves the overall beamforming performance in terms of coverage;
vi. For layer mapping, the algorithm uniformly utilizes the different layers such that the possibility of assigning weak layers more often is minimized; and/or
vii. The shuffling of layer indices every slot introduces time diversity which improves the performance and avoids getting stuck into a local minimum.

According to one aspect, a method in a network node in communication with a wireless device, WD, is provided. The method includes receiving a precoder rank indication, and selecting one of two precoders of different ranks one of cyclically and randomly when the indicated precoder rank is greater than 1.

According to this aspect, in some embodiments, the selecting is performed once per time slot. In some embodiments, selecting includes selecting one of a rank 1 precoder a rank 2 precoder when the precoder rank indication is 2. In some embodiments, selecting includes selecting one of a rank 2 precoder and a rank 3 precoder when the precoder rank indication is greater than 2. In some embodiments, selecting includes selecting one of a precoder of one rank and a precoder of a next-lowest rank. In some embodiments, selecting includes selecting one of the two precoders based at least in part on which one of two precoder columns corresponding to respective ones of the two precoders produces a greater value of a performance function. In some embodiments, the performance function is a function of a transpose of a precoder column times the precoder column. In some embodiments, the performance function includes a Shannon capacity formula. In some embodiments, the Shannon capacity formula is given by f(A)=|log (I+A)|, where A is a precoder column. In some embodiments, the performance function is based at least in part on a determinant over trace metric given by f(A)=|A|/(tr(A)), where A is a precoder column.

According to another aspect, a network node configured to communicate with a wireless device, WD, is provided. The network node includes a radio interface configured to receive a precoder rank indication, and processing circuitry configured to select one of two precoders of different ranks cyclically or randomly when the indicated precoder rank is greater than 1.

According to this aspect, in some embodiments, the selecting is performed once per time slot. In some embodiments, selecting includes selecting one of a rank 1 precoder a rank 2 precoder when the precoder rank indication is 2. In some embodiments, selecting includes selecting one of a rank 2 precoder and a rank 3 precoder when the precoder rank indication is greater than 2. In some embodiments, selecting includes selecting one of a precoder of one rank and a precoder of a next-lowest rank. In some embodiments, selecting includes selecting one of the two precoders based at least in part on which one of two precoder columns corresponding to respective ones of the two precoders produces a greater value of a performance function. In some embodiments, the performance function is a function of a transpose of a precoder column times the precoder column. In some embodiments, the performance function includes a Shannon capacity formula. In some embodiments, the Shannon capacity formula is given by f(A)=|log (I+A)|, where A is a precoder column. In some embodiments, the performance function is based at least in part on a determinant over trace metric given by f(A)=|A|/(tr(A)), where A is a precoder column 1.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 is a flowchart of an example process in a network node for layer mapping and selection according to some embodiments of the present disclosure;

FIG. 4 is a block diagram of a layer mapping and selection process according to principles set forth herein.

### DETAILED DESCRIPTION

Before describing in detail example embodiments, it is noted that the embodiments reside primarily in combinations of apparatus components and processing steps related to diversity-aware truncated layer selection for low complexity beamforming. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide diversity-aware truncated layer selection for low complexity beamforming.

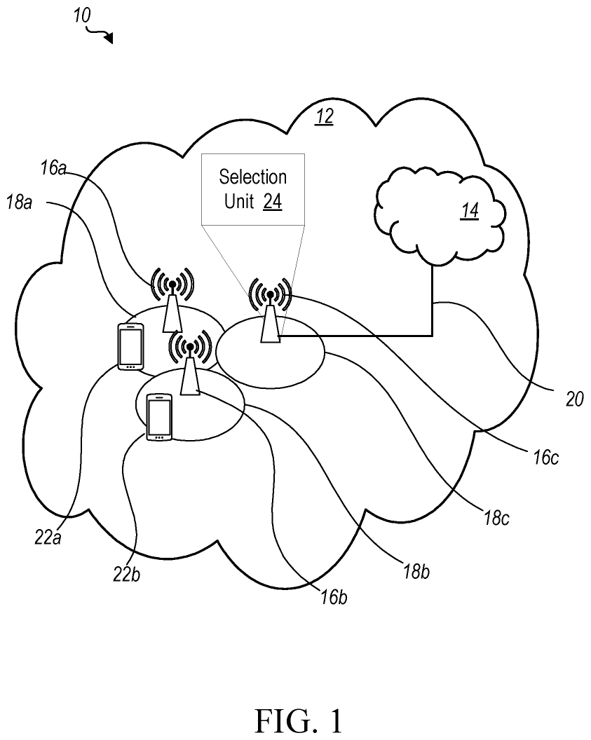

Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a selection unit 24 which is configured to select one of two precoders of different ranks cyclically or randomly when the indicated precoder rank is greater than 1.

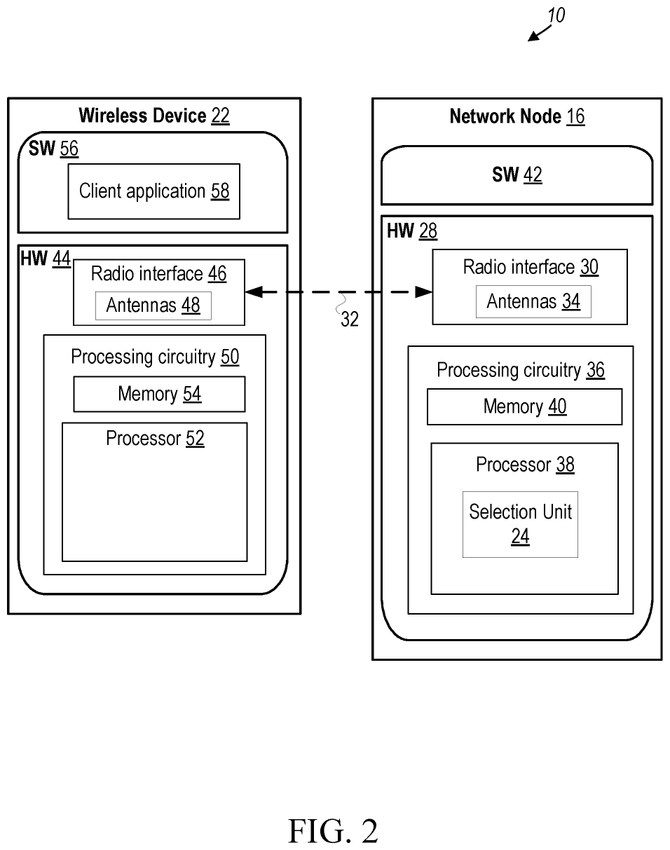

Example implementations, in accordance with an embodiment, of the WD 22 and network node 16 discussed in the preceding paragraphs will now be described with reference to FIG. 2.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a selection unit 24 which is configured to select one of two precoders of different ranks cyclically or randomly when the indicated precoder rank is greater than 1.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory. the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22

In some embodiments, the inner workings of the network node 16 and WD 22 may be as shown in FIG. 2 and independently, the surrounding network topology may be that of FIG. 1.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units” such as selection unit 24 as being within a respective processor, it is contemplated that these units may be implemented such that a portion of the unit is stored in a corresponding memory within the processing circuitry. In other words, the units may be implemented in hardware or in a combination of hardware and software within the processing circuitry.

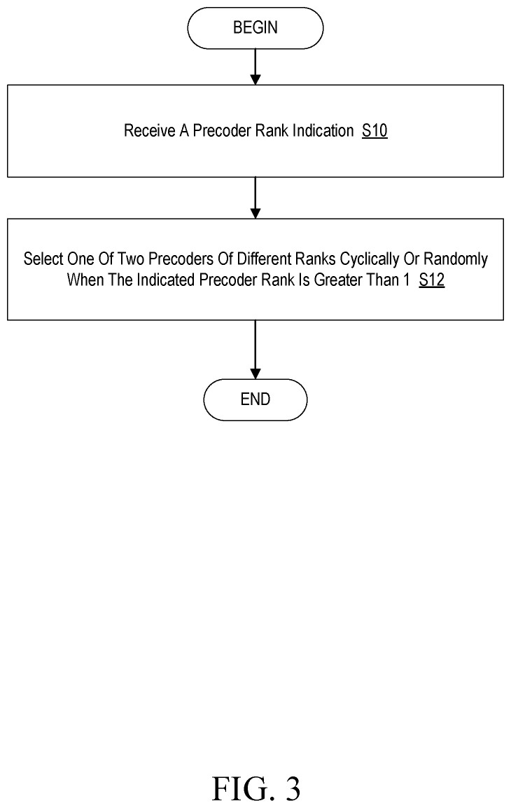

FIG. 3 is a flowchart of an example process in a network node 16 for layer mapping and selection according to principles set forth herein. One or more blocks described herein may be performed by one or more elements of network node 16 such as by one or more of processing circuitry 36 (including the selection unit 24), processor 38, and/or radio interface 30. Network node 16 such as via processing circuitry 36 and/or processor 38 and/or radio interface 30 is configured to receive a precoder rank indication (Block S10). The process also includes selecting one of two precoders of different ranks one of cyclically and randomly when the indicated precoder rank is greater than 1 (Block S12). Having described the general process flow of arrangements of the disclosure and having provided examples of hardware and software arrangements for implementing the processes and functions of the disclosure, the sections below provide details and examples of arrangements for diversity-aware truncated layer selection for low complexity beamforming.

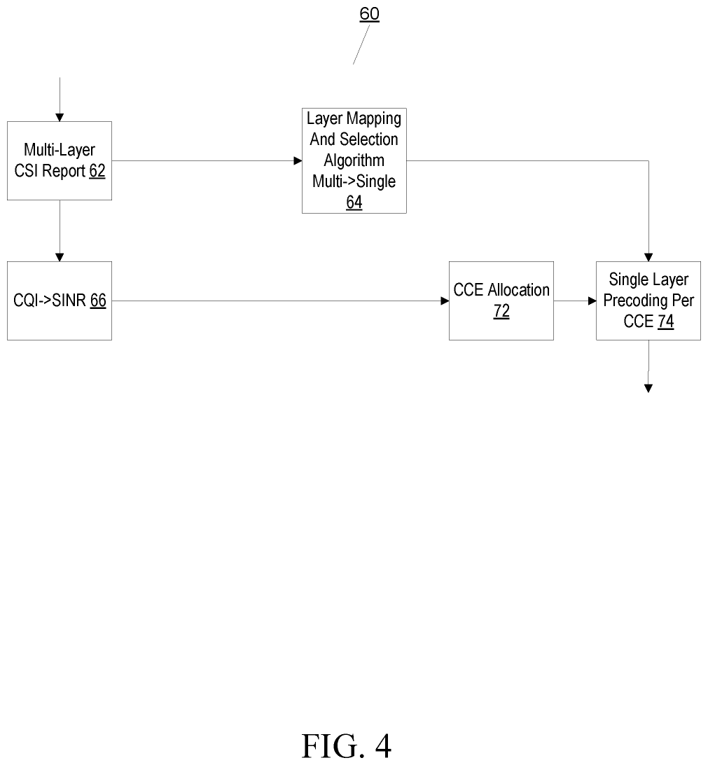

In some embodiments, an precoder selection algorithm makes use of reported precoder weights of a beamformed channel to beamform a channel. This may be employed to beamform a channel that does not have a stand-alone beamforming mechanism of its own. FIG. 4 shows a block diagram of an example process 60 performed in some embodiments for precoder layer mapping and selection. In some embodiments, the process 60 may be performed by processing circuitry 36. First, the PMI precoder weights of the multi-layer transmission are inferred from the multi-layer CSI report 62 received from the WD 22. Using the layer mapping and selection algorithm 64, which may be implemented by the selection unit 24 of the processing circuitry 36, the PMI precoder weights corresponding to the layers to be assigned to the bundles of the single layer transmission channel are chosen. At the same time, a signal to interference plus noise ratio (SINR) correction chain may make corrections to the beamforming (BF) gain of the multi-layer transmission channel by removing this gain and by adding a BF gain suitable for the single-layer transmission channel. Accordingly, in Block 66 an SINR is obtained or inferred from the CQI. Control channel element (CCE) allocations (Block 72) are then carried out and the layers selected by the layer mapping and selection algorithm 64 are used for precoding of the single layer channel per CCE (Block 74). The output of Block 74 are the identities of the precoders allocated to CCEs.

Utilization of PMI precoder weights of a multi-layer transmission to beamform a single-layer transmission is not a straightforward process. There are multiple things to consider such as: hardware and storage space limitations, variable number of layers to use per slot (which depends on the reported rank for the multi-layer transmission), and lack of knowledge of which layer is the strongest. Accordingly, the disclosed truncated layer 2 and 3 selection mechanism successfully maps the PMI precoder weights while mitigating problems discussed above.

To reduce memory storage and abide by hardware limitations, the truncation process, which may be performed by the processing circuitry 36, and in particular the selection unit 24, helps limit the number of layers to be used up to 3 layers. This may be done as follows:
I. If the user reports rank 1;
   This is a single-layer to single-layer transmission mapping. Therefore, there is only one layer to work with.
II. If the user reports rank 2:
   This is a two-layer to single-layer transmission mapping. Therefore, the layer selection algorithm makes use of both layers and assigns them cyclically to the bundles of the single-layer transmission channel.
III. If the user reports rank 3:
   This is a three-layer to single-layer transmission mapping. Therefore, to limit the number of layers to two, the discloses layer selection algorithm would discard the first layer and only assign layers two and three cyclically to the bundles of the single-layer transmission channel.
IV. If the user reports rank 4:
   This is a four-layer to single-layer transmission mapping. Therefore, to limit the number of layers to two, the disclosed layer selection algorithm would discard the first and fourth layers and only assign layers two and three cyclically to the bundles of the single-layer transmission channel.

By truncating the first and/or fourth layers and allow the use of layers 2 and 3, both directional and phase diversity may be achieved. As shown in the TABLE 1, Layers 1 and 3 are identical in direction but have different phases. Similarly, layers 2 and 4 are identical in direction but have different phases. Accordingly, in some embodiments of the algorithm, either layer 1 alone, layers 1 and 2, or layers 2 and 3 are used. This guarantees directional and phase diversity, which in turn improves performance and overall system stability.

TABLE 1
codebookMode = 1-2, P_{CSI-RS} ≥ 16

| i_{1,1} | i_{1,2} | i_{1,3} | i₂ | |
|---|---|---|---|---|
| $0 , … , \frac{{N}_{1} {O}_{1}}{2} - 1$ | 0, . . . , N₂O₂ −1 | 0,1,2,3 | 0,1 | Wᵢ_{_{1,1}},ᵢ_{_{1,2}},ᵢ_{_{1,3}},ᵢ_{₂}⁽⁴⁾ |

$where {W}_{l , m , p , n}^{( 4 )} = \frac{1}{\sqrt{4 {P}_{CSI - RS}}} [ \begin{matrix}{\tilde{v}}_{l , m} & {\tilde{v}}_{l , m} & {\tilde{v}}_{l , m} & {\tilde{v}}_{l , m} \\ {θ}_{p} {\tilde{v}}_{l , m} & - {θ}_{p} {\tilde{v}}_{l , m} & {θ}_{p} {\tilde{v}}_{l , m} & - {θ}_{p} {\tilde{v}}_{l , m} \\ {φ}_{n} {\tilde{v}}_{l , m} & {φ}_{n} {\tilde{v}}_{l , m} & - {φ}_{n} {\tilde{v}}_{l , m} & - {φ}_{n} {\tilde{v}}_{l , m} \\ {φ}_{n} {θ}_{p} {\tilde{v}}_{l , m} & - {φ}_{n} {θ}_{p} {\tilde{v}}_{l , m} & - {φ}_{n} {θ}_{p} {\tilde{v}}_{l , m} & {φ}_{n} {θ}_{p} {\tilde{v}}_{l , m}\end{matrix} ] .$

The disclosed truncation method makes use of the fact that layers are formed in the way described in the above table. By using layers 1, 2, and 3 at any point in time and always truncating only layer 4, some embodiments preserve directional and polarization gains. Additionally, rank 4 rarely occurs, since it requires almost perfect channel state and a WD which is experiencing high SINR. Therefore, the loss due to truncation is not significant.

Also, the number of layers to select from is variable as it depends on the rank reported by the user. Therefore, some embodiments proved a layer selection algorithm that is adaptable and can handle different scenarios independently. The layer selection algorithm may present layer selection sequences that are time-diverse while saving hardware memory space.

Generally, it may be useful to always select the strongest layer and assign it to the bundles of the single-layer transmission channel. However, knowing which layer is the strongest is not possible. To resolve this matter, the layer selection algorithm disclosed herein employs a shuffling mechanism where the layer indices are shuffled first before being assigned to the bundles. This shuffling process adds randomness which allows for sufficient time diversity. By doing so, especially with truncation to two layers, we ensure that weak and strong layers would be used equally on average. This reduces the possibility of selecting a weak layer more often and hence would improve the average long-term performance. Additionally, by truncating the number of layers, the complexity of the algorithm shuffling reduces significantly.

While the above descriptions are based on a 3GPP codebook structure, the disclosed method is readily applicable to other codebook structures that utilize dual-diversity transmissions. Whether the multi-layer precoder information is obtained as part of a feedback mechanism or obtained from uplink sounding based training, some embodiments of the disclosed method introduce an additional module that operates on the resulting multi-layer codebook and produces a lower rank precoder by a simple selection mechanism where the columns of the selected precoder can be determined by:

$${max}_{v} f ( {F}_{v}^{H} {F}_{v} )$$

where f(·) is a performance related function (such as the one similar to a Shannon-capacity formula f(A)=|log (I+A)| or determinant over trace metric

$$f ( A ) = \frac{\vert A \vert}{tr ( A )}$$

that is a measure of orthogonality of columns of precoder

$${F}_{v} = [ {f}_{{v}_{0}} … {f}_{{v}_{{N}_{s} - 1}} ] )$$

with v denoting the selected columns of original precoder F.

A simple and efficient layer selection and beamforming algorithm is disclosed that intelligently maps the PMI precoder weights of a multi-layer transmission channel into a single layer transmission or transmission on two layers. In some embodiments, the number of layers to assign to bundles is truncated to a maximum of two every slot, leading to a reduction in the amount of memory needed to store precoder weights. The layer truncating is performed in a way that maintains directional and phase diversity. This is especially prominent in environments with high multi-path. The indices of the truncated list of layers are then shuffled and cyclically assigned to bundles. In some embodiments, the disclosed algorithm is also of low complexity and resolves many implementation challenges. Overall, the disclosed algorithm outperforms the single-layer transmission channels that rely on common beamforming such as PDCCH.

According to one aspect, a method in a network node 16 in communication with a wireless device 22 is provided. The method includes receiving a precoder rank indication, and selecting one of two precoders of different ranks one of cyclically and randomly when the indicated precoder rank is greater than 1.

According to this aspect, in some embodiments, the selecting is performed once per time slot. In some embodiments, selecting includes selecting one of a rank 1 precoder a rank 2 precoder when the precoder rank indication is 2. In some embodiments, selecting includes selecting one of a rank 2 precoder and a rank 3 precoder when the precoder rank indication is greater than 2. In some embodiments, selecting includes selecting one of a precoder of one rank and a precoder of a next-lowest rank. In some embodiments, selecting includes selecting one of the two precoders based at least in part on which one of two precoder columns corresponding to respective ones of the two precoders produces a greater value of a performance function. In some embodiments, the performance function is a function of a transpose of a precoder column times the precoder column. In some embodiments, the performance function includes a Shannon capacity formula. In some embodiments, the Shannon capacity formula is given by f(A)=|log (I+A)|, where A is a precoder column. In some embodiments, the performance function is based at least in part on a determinant over trace metric given by f(A)=|A|/(tr(A)), where A is a precoder column.

According to another aspect, a network node 16 configured to communicate with a wireless device, WD, is provided. The network node 16 includes a radio interface 30 configured to receive a precoder rank indication, and processing circuitry 36 configured to select one of two precoders of different ranks cyclically or randomly when the indicated precoder rank is greater than 1.

According to this aspect, in some embodiments, the selecting is performed once per time slot. In some embodiments, selecting includes selecting one of a rank 1 precoder a rank 2 precoder when the precoder rank indication is 2. In some embodiments, selecting includes selecting one of a rank 2 precoder and a rank 3 precoder when the precoder rank indication is greater than 2. In some embodiments, selecting includes selecting one of a precoder of one rank and a precoder of a next-lowest rank. In some embodiments, selecting includes selecting one of the two precoders based at least in part on which one of two precoder columns corresponding to respective ones of the two precoders produces a greater value of a performance function. In some embodiments, the performance function is a function of a transpose of a precoder column times the precoder column. In some embodiments, the performance function includes a Shannon capacity formula. In some embodiments, the Shannon capacity formula is given by f(A)=|log (I+A)|, where A is a precoder column. In some embodiments, the performance function is based at least in part on a determinant over trace metric given by f(A)=|A|/(tr(A)), where A is a precoder column 1.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may appear in this disclosure include the following:
3GPP Third Generation Partnership Project
5G Fifth Generation
ACK Acknowledgment
BWP Bandwidth Part
CE Control element
CG Configured Grant
CCA Clear Channel Assessment
CP Cyclic Prefix
CSI Channel State Information
CSI-RS CSI Reference Signal
CQI Channel Quality Indicator
DCI Downlink Control Information
DFI Downlink Feedback Information
DL Downlink
DRB Data Radio Bearer
eNB eNodeB
FDMA Frequency Division Multiple Access
FDD Frequency Division Duplex
gNB gNodeB
HARQ Hybrid Automatic Repeat Request
HO Handover
IAB Integrated Access and Backhaul
IE Information Element
LBT Listen Before Talk
LCH Logical Channel
LCG Logical Channel Group
LTE Long Term Evolution
MAC Medium Access Control
MAC CE MAC Control Element
MCS Modulation and Coding Scheme
NACK Negative Acknowledgement
NR New Radio
OFDM Orthogonal Frequency-Division Multiplexing
PA Power Amplifier
PMI Precoding Matrix Indicator
PDCCH Physical Downlink Control Channel
PDSCH Physical Downlink Shared Channel
PUCCH Physical Uplink Control Channel
PUSCH Physical Uplink Shared Channel
QOS Quality of Service
RI Rank Indicator
RV Redundancy Version
RRC Radio Resource Control
RSRP Reference Signal Received Power
RSSI Received Signal Strength Indicator
RSRQ Reference Signal Received Quality
SCS Sub-Carrier Spacing
SI System Information
SINR Signal to Interference plus Noise Ratio
SNR Signal to Noise Ratio
SG Scheduling Grant
SRB Signaling Radio Bearer
SRI Sounding Reference Signals (SRS) Resource Indicator
SLIV Start and Length Indicator Value
TO Transmission Occasion
TDD Time Division Duplex
TDMA Time Division Multiple Access
UCI Uplink Control Information
UE User Equipment
UL Uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node in communication with a wireless device, WD, the method comprising:
receiving a precoder rank indication; and
selecting one of two precoders of different ranks one of cyclically and randomly when the indicated precoder rank is greater than 1.

2. The method of claim 1, wherein, the selecting is performed once per time slot.

3. The method of claim 1, wherein selecting includes selecting one of a rank 1 precoder a rank 2 precoder when the precoder rank indication is 2.

4. The method of claim 1, wherein selecting includes selecting one of a rank 2 precoder and a rank 3 precoder when the precoder rank indication is greater than 2.

5. The method of claim 1, wherein selecting includes selecting one of a precoder of one rank and a precoder of a next-lowest rank.

6. The method of claim 1, wherein selecting includes selecting one of the two precoders based at least in part on which one of two precoder columns corresponding to respective ones of the two precoders produces a greater value of a performance function.

7. The method of claim 6, wherein the performance function is a function of a transpose of a precoder column times the precoder column.

8. The method of claim 6, wherein the performance function includes a Shannon capacity formula.

9. The method of claim 8, wherein the Shannon capacity formula is given by f(A)=|log (I+A)|, where A is a precoder column.

10. The method of claim 6, wherein the performance function is based at least in part on a determinant over trace metric given by f(A)=|A|/(tr(A)), where A is a precoder column.

11. A network node configured to communicate with a wireless device, WD, the network node comprising:
a radio interface configured to receive a precoder rank indication; and
processing circuitry configured to select one of two precoders of different ranks cyclically or randomly when the indicated precoder rank is greater than 1.

12. The network node of claim 11, wherein, the selecting is performed once per time slot.

13. The network node of claim 11, wherein selecting includes selecting one of a rank 1 precoder a rank 2 precoder when the precoder rank indication is 2.

14. The network node of claim 11, wherein selecting includes selecting one of a rank 2 precoder and a rank 3 precoder when the precoder rank indication is greater than 2.

15. The network node of claim 11, wherein selecting includes selecting one of a precoder of one rank and a precoder of a next-lowest rank.

16. The network node of claim 11, wherein selecting includes selecting one of the two precoders based at least in part on which one of two precoder columns corresponding to respective ones of the two precoders produces a greater value of a performance function.

17. The network node of claim 16, wherein the performance function is a function of a transpose of a precoder column times the precoder column.

18. The network node of claim 16, wherein the performance function includes a Shannon capacity formula.

19. The network node of claim 18, wherein the Shannon capacity formula is given by f(A)=|log (I+A)|, where A is a precoder column.

20. The network node of claim 16, wherein the performance function is based at least in part on a determinant over trace metric given by f(A)=|A|/(tr(A)), where A is a precoder column 1.
